(19) United States
(12) Patent Application Publication
(10) Pub. No.: US 2005/0107570 A1
(43) Pub. Date: May 19, 2005

(54) Method of producing phenol novolak resin

(75) Inventors: Noriaki Saitou, Toyonaka-shi (JP); Takayuki Otsuka, Niihama-shi (JP); Kohichi Fukuda, Niihama-shi (JP); Masahiro Fujiwara, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/947,157

(22) Filed: Sep. 23, 2004

(30) Foreign Application Priority Data
Sep. 25, 2003 (JP) 2003-333157

(51) Int. Cl. C08G 8/04; C08G 14/02

(52) U.S. Cl. 528/143

(57) ABSTRACT

Provided is a process for producing a phenol novolak resin having an ortho ratio of 30 to 60%, wherein a phenolic compound and an aldehyde are reacted in the presence of an aromatic sulfonic acid catalyst at a temperature of 110 to 160° C. under pressurized condition, and the amount of remaining oxalic acid and formic acid is reduced and the corrosion property to a reaction apparatus is decreased.

### BACKGROUND OF THE INVENTION

1. Field of the Invention

The present invention relates to a method of producing a phenol novolak resin.

2. Description of the Related Art

A phenol novolak resin used as a raw material of a thermosetting resin and the like is obtained by reacting a phenolic compound with an aldehyde. It is known that reactivity of a phenol novolak resin with a hardener such as hexamethylenetetramine and the like increases in proportion to the ortho ratio in the phenol novolak resin, namely, the proportion of carbon atoms derived from a —CHO group of aldehyde bonded to phenolic compound at ortho position of the hydroxyl group (“Phenol resin”, published by Plastic Age K.K., 1987, pp 48 to 52). Regarding this knowledge, there are suggested methods of producing phenol novolak resins having various ortho ratios.

For example, as a production method giving a phenol novolak resin having an ortho ratio of around 40%, there is suggested a production method in which a phenolic compound and formalin are reacted under pressurized condition using oxalic acid as a catalyst, subsequently, reacted under pressurized condition by further adding p-toluenesulfonic acid as a catalyst (JP-A No. 2002-348346).

On the other hand, as a production method giving a phenol novolak resin having an ortho ratio of around 20%, there is also suggested a production method in which a phenolic compound and formalin are reacted under atmospheric pressure using only p-toluenesulfonic acid as a catalyst (JP-A No. 2002-179749).

However, in the production method using both oxalic acid and p-toluenesulfonic acid as catalysts as described above, there has been an industrial problem that formic acid generated by decomposition of oxalic acid or oxalic acid itself has a volatile property or sublimation property, and oxalic acid and formic acid show a corrosion property to metals, therefore, an anti-corrosive material is necessary not only for a reaction apparatus but also for a condenser equipped in the reaction apparatus. If oxalic acid or formic acid remains in a phenol novolak resin, when the resin is applied to industrial products such electronic parts and the like, there is also a possibility of generation of defects in the industrial products due to corrosion of metal parts of electronic parts and the like.

### SUMMARY OF THE INVENTION

An object of the present invention is to provide a production method of a phenol novolak resin having an ortho ratio of 30 to 60%, wherein the remaining amount of oxalic acid and formic acid is reduced, and a corrosion property to a reaction apparatus is decreased.

Namely, the present invention provides a method of producing a phenol novolak resin wherein a phenolic compound and an aldehyde are reacted in the presence of an aromatic sulfonic acid catalyst at 110 to 160° C. under pressurized condition.

### DETAILED DESCRIPTION OF THE INVENTION

The phenolic compound used in the present invention is not particularly restricted, and for example, those represented by the following formulae (1) to (3) can be preferably used. 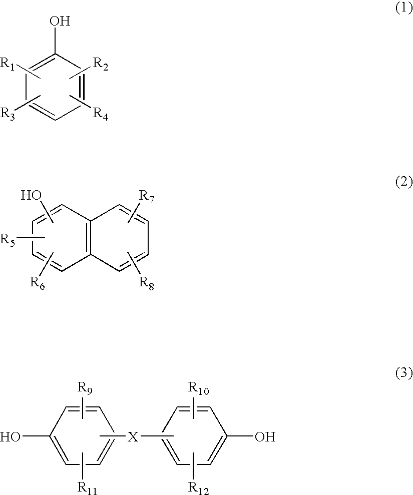
wherein, R₁ to R₁₂ each independently represent a hydrogen atom, halogen atom, aryl group having 6 to 20 carbon atoms, alkyl group having 1 to 20 carbon atoms, cycloalkyl group having 5 to 20 carbon atoms or aralkyl group having 7 to 20 carbon atoms; and X represents a single bond, arylene group having 6 to 20 carbon atoms, alkylene group having 1 to 20 carbon atoms, alkylidene group having 2 to 20 carbon atoms, cycloalkylidene group having 5 to 20 carbon atoms or aralkylidene group having 7 to 20 carbon atoms.

Examples of the aryl group having 6 to 20 carbon atoms include a phenyl group, naphthyl group, biphenyl group and the like. In these aryl groups, a substituent such as a methyl group, ethyl group, propyl group, butyl group and the like may be present. The number of carbon atoms in the aryl groups herein mentioned includes the number of carbon atoms of a substituent. Examples of the alkyl group having 1 to 20 carbon atoms includes straight chain and branched hydrocarbon groups such as a methyl group, ethyl group, n-propyl group, iso-propyl group, n-butyl group, iso-butyl group, tert-butyl group, n-pentyl group, iso-pentyl group, tert-pentyl group, n-hexyl group, iso-hexyl group, tert-hexyl group and the like. Examples of the cycloalkyl group having 5 to 20 carbon atoms include cyclic hydrocarbon groups such as a cyclopentyl group, cyclohexyl group and the like. Examples of the aralkyl group having 7 to 20 carbon atoms include a phenylmethyl group, phenylethyl group, phenylpropyl group, diphenylmethyl group and the like. Examples of the halogen atom include fluorine, chlorine, bromine and the like. Examples of the arylene group having 6 to 20 carbon atoms include a phenylene group, naphthylene group, biphenylene group and the like. Examples of the alkylene group having 1 to 20 carbon atoms include a methylene group, dimethylene group, trimethylene group and the like. Examples of the alkylidene group having 7 to 20 carbon atoms include an ethylidene group, propylidene group, butylidene group and the like. Examples of the cycloalkylidene group having 5 to 20 carbon atoms include a cyclopentylidene group, cyclohexylidene group and the like. Examples of the aralkylidene group having 7 to 20 carbon atoms include a phenylmethylidene group, 1-phenyl-1,1′-ethylidene group, 1-phenyl-1,1′-propylidene group and the like.

In R₁ to R₁₂, the number of carbon atoms of the aryl group is preferably 6 to 10, the number of carbon atoms of the alkyl group is preferably 1 to 10, the number of carbon atoms of the cycloalkyl group is preferably 5 to 10, the number of carbon atoms of the aralkyl group is preferably 7 to 10. In X, the number of carbon atoms of the arylene group is preferably 6 to 10, the number of carbon atoms of the alkylene group is preferably 1 to 10, the number of carbon atoms of the alkylidene group is preferably 1 to 10, the number of carbon atoms of the cycloalkylidene group is preferably 5 to 10, and the number of carbon atoms of the aralkylidene group is preferably 7 to 10.

The phenolic compound may also be used in combination of two or more thereof.

Specific examples of the phenolic compound represented by formula (1) include phenol, alkyl-substituted phenols such as cresol, xylenol, ethylphenol, propylphenol, butylphenol, butylmethylphenol, cumylphenol and the like, aryl-substituted phenols such as phenylphenol and the like, and halogenated phenols such as fluorophenol, chlorophenol, bromophenol and the like.

Specific examples of the phenolic compound represented by formula (2) include naphthol, methylnaphthol, ethylnaphthol, propylnaphthol, butylnaphtol and the like.

Specific examples of the phenolic compound represented by formula (3) include biphenol, tetramethylbiphenol, bisphenol A, bisphenol F, bisphenol AD, bisphenolfluorene, bisphenolcyclohexane and the like.

As the phenolic compounds represented by the above formulae (1) to (3), particularly preferable are those in which at least two reaction positions in the phenolic compounds (reaction positions active in an electrophilic substitution reaction, such as para position and ortho position to the phenolic hydroxyl group) are not substituted.

As the phenolic compounds used in the present invention, phenol, cresol, xylenol, butylmethylphenol, phenylphenol, biphenol, naphthol, bisphenol A and bisphenol F are preferable, and phenol and cresol are more preferable.

The aldehyde used in the present invention will be described below.

Examples of the aldehyde used in the present invention include aliphatic aldehydes such as formaldehyde, acetaldehyde, butylaldehyde, glyoxal and the like, unsaturated aliphatic aldehydes such as acrolein and the like, aromatic aldehydes such as benzaldehyde, hydroxybenzaldehyde and the like, and unsaturated aromatic aldehydes such as cinnamic aldehyde and the like. AS the aldehydes, formaldehyde is preferable. Regarding formaldehyde, formalin which is an aqueous solution of formaldehyde, and those such as paraform, trioxane and the like which are solid at room temperature, are more preferable from the standpoint of handling. The amount of aldehyde is usually from 0.5 to 0.99 mol based on the phenolic compound though depending on the intended molecular weight of the phenol novolak resin.

Next, the catalyst used in the present invention will be described.

It is necessary that the catalyst used in the present invention contains at least one of aromatic sulfonic acids. As such aromatic sulfonic acids, for example, benzenesulfonic acid, toluenesulfonic acid and the like are listed. As the aromatic sulfonic acids, those in the form of aqueous solution may be used. The amount of aromatic sulfonic acids is usually from 0.0001 to 0.01 mol based on the phenolic compound. If necessary, it is possible to use an inorganic acid such as sulfuric acid and the like together, in addition to aromatic sulfonic acids. The total amount of catalysts in this case is usually from 0.0001 to 0.01 mol based on phenolic compound.

In the present invention, it is necessary that a phenolic compound and an aldehyde are reacted under pressurized condition at a reaction temperature in the range from 110 to 160° C., using an phenolic compound, an aldehyde and aromatic sulfonic acids as catalyst. When the reaction temperature is lower than 110° C., the reaction speed lowers, and when higher than 160° C., the reaction becomes too fast, undesirably. The reaction temperature is preferably in the range from 120 to 150° C. By changing the reaction temperature, the ortho ratio can be controlled. Namely, the ortho ratio increases when reacted at a higher temperature and decreased when reacted at a lower temperature.

The pressure in conducting the reaction is usually in the range from 0.01 to 0.15 MPa, and preferably in the range from 0.05 to 0.10 MPa.

The present invention can be carried out, for example, as described below. Into an autoclave equipped with a thermometer and a stirrer, a phenolic compound and an aromatic sulfonic acid are charged, and the atmosphere is purged with nitrogen, then, the autoclave is closed and the temperature is raised. Next, an aldehyde is continuously or discontinuously added at a given temperature, and the temperature is kept until completion of the reaction. Thereafter, if necessary, operations such as neutralization with an alkali, washing with water, dehydration under a reduced pressure, stripping and the like can be conducted to obtain a phenol novolak resin having an ortho ratio of 30 to 60% and having a small remaining amount of oxalic acid, formic acid and salts thereof.

### EXAMPLES

The present invention will be illustrated in detail by examples, but the scope of the invention is not limited to the examples. Measurement methods in the examples are as described below.

Ortho ratio: For compounds having a structure in which two phenol molecules are bonded, ratios of three isomers (ortho-ortho moiety, ortho-para moiety, and para-para moiety; they have different form of bonding between phenols and the carbon atom derived from aldehyde) were measured by gas chromatograph, and the ortho ratio was calculated as follows: ortho ratio (%)=ortho-ortho moiety (%)+ortho-para moiety (%)/2.

Softening point: It was measured by a ring & ball method.

Content of oxalic acid and formic acid: After dissolution in toluene, ion exchange water is added and the mixture is shaken, and the content of oxalic acid and formic acid in the extraction water was quantified by ion chromatograph. (detection limit: 0.1 ppm)

### Example 1

Into a pressure-resistant reaction vessel equipped with a thermometer, a stirrer and a formalin injection pump, 324 g of orthocresol and 0.29 g of p-toluenesulfonic acid (monohydrate salt) were charged and dissolved. After the inner atmosphere was purged with nitrogen, the vessel was sealed and the temperature was raised. While keeping at 130° C., 194.6 g of 37% formalin was added over 2 hours, and the temperature was kept for 2 hours, then, 5.7 g of a 50% p-toluenesulfonic acid (monohydrate salt) aqueous solution was added, further, the temperature was kept at 130° C. in 1 hour. The pressure during this reaction was 0.33 MPa at maximum. Thereafter, the temperature was lowered to 85° C. and the pressure was returned to atmospheric pressure, then, the mixture was neutralized with a 10% sodium hydroxide solution. After washing with water, water and un-reacted monomers were removed by distillation under reduced pressure, further, stripping was conducted until the remaining orthocresol content reached 1000 ppm or less, to obtain an orthocresol novolak resin. The ortho ratio was 42%, the softening point was 91° C., and the content of oxalic acid and formic acid in the resin was not more than detection limit.

### Example 2

The same operation as in Example 2 was conducted except that the reaction temperature was 120° C., to obtain an orthocresol novolak resin. The ortho ratio was 35%, the softening point was 90° C., and the content of oxalic acid and formic acid was not more than detection limit.

### Example 3

The same operation as in Example 2 was conducted except that the reaction temperature was 140° C., to obtain an orthocresol novolak resin. The ortho ratio was 48%, the softening point was 91° C., and the content of oxalic acid and formic acid was not more than detection limit.

### Example 4

The same operation as in Example 2 was conducted except that 205.5 g of 37% formalin was used, to obtain 352.1 g (yield: 99.8%) of an orthocresol novolak resin. The ortho ratio was 40%, the softening point was 109° C., and the content of oxalic acid and formic acid was not more than detection limit.

### Example 5

The same operation as in Example 2 was conducted except that 216.5 g of 37% formalin was used, to obtain an orthocresol novolak resin. The ortho ratio was 41%, the softening point was 124° C., and the content of oxalic acid and formic acid was not more than detection limit.

### Comparative Example 1

Into the same apparatus as in Example 1, 324 g of orthocresol and 3.78 g of oxalic acid (dihydrate) were charged and dissolved, then, the inner atmosphere was purged with nitrogen, the vessel was sealed and the temperature was raised. While keeping at 130° C., 194.6 g of 37% formalin was poured over 2 hours, and the temperature was kept for 2 hours, then, 5.7 g of a 50% p-toluenesulfonic acid (monohydrate salt) aqueous solution was added, further, the temperature was kept for 1 hour. The pressure during this reaction was 0.34 MPa at maximum. Thereafter, the temperature was lowered to 85° C. and the pressure was returned to atmospheric pressure, then, the mixture was neutralized with a 10% sodium hydroxide solution. After washing with water once, then, water and un-reacted monomers were removed by distillation under reduced pressure, further, stripping was conducted until the remaining orthocresol content reached 1000 ppm or less, to obtain an orthocresol novolak resin. The ortho ratio was 40%, the softening point was 92° C., the content of oxalic acid in the resin was 1400 ppm, and the content of formic acid was 220 ppm.

### Example 6

In the same apparatus as in Example 1, a test piece for a corrosion test (JIS SUS 329J4L (25 Cr-7Ni-3 Mo)) was installed, and the experiment was repeated three times under the same conditions as in Example 1. When the surface of the test piece was observed, no change was found, and the corrosion rate calculated from change in weight was 0.01 mm/year.

### Comparative Example 2

To the same apparatus as in Example 1, a test piece for a corrosion test (JIS SUS 329J4L (25 Cr-7Ni-3 Mo)) was installed, and the experiment was repeated three times under the same conditions as in Comparative Example 1. When the surface of the test piece was observed, corrosion on the whole surface was found, and the corrosion rate calculated from change in weight was 2.7 mm/year.

According to the present invention, a production method of a phenol novolak resin having an ortho ratio of 30 to 60% is provided, wherein the remaining amount of oxalic acid and formic acid is very little, and a corrosion property to a reaction apparatus is decreased.

1. A method of producing a phenol novolak resin wherein a phenolic compound and an aldehyde are reacted in the presence of an aromatic sulfonic acid catalyst at a temperature of 110 to 160° C. under pressurized condition.

2. A method of producing a phenol novolak resin according to claim 1, wherein the pressurized condition is 0.01 to 0.15 MPa.

3. A method of producing a phenol novolak resin according to claim 1, wherein the aldehyde is formalin.

4. A method of producing a phenol novolak resin according to claim 1, wherein the phenolic compound is orthocresol.

5. A phenol novolak resin obtained by a method according to any one of claims 1 to 3.
